(19) United States
(12) Patent Application Publication
(10) Pub. No.: US 2016/0349143 A1
(43) Pub. Date: Dec. 1, 2016

(54) Systems, Methods, and Apparatuses For a Vibratory Source

(71) Applicant: Peter S. Aronstam, Houston, TX (US)

(72) Inventor: Peter S. Aronstam, Houston, TX (US)

(21) Appl. No.: 14/727,817

(22) Filed: Jun. 1, 2015

(51) Int. Cl. G01M 7/02

(52) U.S. Cl. CPC G01M 7/022

(57) ABSTRACT

A vibration source described herein may utilize spinning weights to create vibrations in one or more controlled directions. By placing the two rotating masses in a position along the axis of the tool and counter-rotating the masses, it is possible to cancel the rotational output of the individual spinning eccentric masses and yield a uni-directional linear vibration. The rotation of the masses may also be controlled by a processor to change the direction of the vibration in real-time. Thus, the vibration source may be utilized in geologic interrogation or communications.

### CROSS REFERENCE TO RELATED APPLICATION

This non-provisional patent application claims the benefit of priority to provisional application No. 62/007,139 (“Method and Apparatus for Vibratory Source”), filed Jun. 3, 2014, which is hereby incorporated by reference in its entirety.

### FIELD OF THE EMBODIMENTS

The embodiments relate generally to systems, apparatuses, and methods for creating linear vibrations in a structure, and, more specifically, to acoustic vibratory sources used to interrogate structures or communicate through the earth.

### BACKGROUND

Historically, linear vibrators have been activated using hydraulic power, moving a mass in a linear chamber, and switching the hydraulic pressure between ends of the chamber to effect a sinusoidal motion of the mass. Although effective in creating vibrations, the complexity and size of the control systems and hydraulic pumps make use restricted to surface applications using very large truck frames to carry the equipment. The concept has been tested in the borehole environment, however the cost and complexity of the system has precluded its wide acceptance and commercial success in such an environment.

A second common method is to use an eccentric mass driven by rotary source. This however creates a circularly polarized vibration which is of less value in geologic investigations due to the complex waveform generated. These devices have been successfully used in the confined spaces of an underground borehole, but have not found widespread acceptance.

Such devices wobble in the borehole environment causing variable fluid pressure against the borehole wall and create an undesirable acoustic signal in the surrounding rock strata.

Based on at least these problems, a need exists for an improved vibratory source.

### SUMMARY

Embodiments described herein include systems, apparatuses, and methods for creating constrained linear vibrations by using a phased set or sets of eccentric masses, driven in a counter-rotating manner. In an embodiment, by placing the two rotating masses in a position along the axis of the tool and counter-rotating the masses, it is possible to cancel the rotational output of the individual spinning eccentric mass and yield a uni-directional linear vibration. In one embodiment, the masses may include at least a first pair and second pair of masses, the first pair being substantially parallel to, and mirroring, the second pair. In one embodiment, both pairs of masses may be oriented on a body relative to the desired direction of linear vibration. In another embodiment, additional pairs of masses may be connected to the body to change the power and/or direction of linear vibration.

In an embodiment, the direction of vibration can be changed by allowing the phase of the masses to shift to a new position, moving the point where both masses pass each other. This may create a more pure wave field for use in the geologic interrogation of the earth in an embodiment. It may also allow for creation of other modes, such as shear waves.

In one embodiment, a vibrator comprises a transmission assembly with first and second weights coupled to the transmission assembly. The first and second weights spin in opposite directions on a first axis of rotation. Third and fourth weights may also be coupled to the transmission assembly, wherein the third and fourth weights spin in opposite directions on a second axis of rotation and the third weight spins in an opposite direction from the first weight. In an embodiment, the first axis of rotation is parallel to the second axis of rotation, and the first and third weights are mirrored relative to one another. This may allow a first direction of vibration to extend through the first axis of rotation and a point where the first and second weights pass one another.

In one embodiment, the transmission assembly includes separate motors for at least the first and third weights. It may also include separate motors for the second and fourth weights. The motors may be controlled by a processor to adjust a first phase of where the first and second weights pass each other to match a second phase of where the third and fourth weights pass each other. This may allow for adjusting the direction of vibration and ensuring that the two sets of weight are working constructively in that direction while cancelling forces in other directions to reduce wobble.

Additionally, by controlling the relative positions and rates of spin of the masses, additional vibrational patterns may be created. Thus, while the particulars for the embodiments as described are for application in a borehole environment for either interrogation of the earth or for signaling data up and down the wellbore, an embodiment may be equally suited to other tasks.

It is to be understood that both the foregoing general description and the following detailed description are exemplary and explanatory only and are not restrictive of the embodiments, as claimed.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is an exemplary illustration of a vibrator in the prior art;

FIG. 2 is an exemplary grapy of waveforms that may be produced by the prior art vibrator of FIG. 1;

FIG. 3 is an exemplary illustration of a system in accordance with an embodiment;

FIG. 4 is an exemplary illustration of a system in accordance with an embodiment;

FIG. 5 is an exemplary illustration of a system with off-center weights that produces unwanted rotational movement;

FIG. 6 is an exemplary illustration of a system in accordance with an embodiment;

FIG. 7 is an exemplary illustration of a system in accordance with an embodiment;

FIGS. 8A and 8B are exemplary illustrations of a system in accordance with an embodiment;

FIG. 9 is an exemplary illustration of a system in accordance with an embodiment;

FIG. 10 is an exemplary illustration of a system in accordance with an embodiment;

FIGS. 11A-B are exemplary graphs of force vectors produced by a system in accordance with an embodiment;

FIG. 12 is an exemplary graph of force vectors produced by a system in accordance with an embodiment;

FIG. 13 is an exemplary illustration of system components in accordance with an embodiment;

FIG. 14 is an exemplary illustration of system components in accordance with an embodiment; and

FIG. 15 is an exemplary flow chart of steps performed in accordance with an embodiment.

### DESCRIPTION OF THE EMBODIMENTS

Reference will now be made in detail to the present exemplary embodiments, including examples illustrated in the accompanying drawings. Wherever possible, the same reference numbers will be used throughout the drawings to refer to the same or like parts.

Exemplary embodiments herein include a vibrator that may be controlled to vibrate in substantially a linear direction based on motorized weights that rotationally counterbalance. The vibrator may be used as a controlled acoustic source with a variety of geophysical applications, depending on the embodiment.

For example, in one embodiment, a user may vary the source vibration direction to illuminate a subsurface target with compressional (P), vertical shear (Sv), and/or horizontal Shear (Sh) waves. The response of the target to these different waves may yield clues as to the physical nature of the target. As an example, shear waves are often attenuated in the presence of gas, whereas compressional waves may experience a strong reflection. This method may be used to differentiate gas deposits in the subsurface.

In another application, vibratory sources can be used to initiate fluid waves or tube waves in boreholes. These later modes travel at the interface of the formation and fluid (i.e., the well bore boundary) and suffer relatively little attenuation, and can be used as secondary sources or other applications. A multi-axis controlled-direction vibrator may allow generation of both symmetric and rotational tube waves in an embodiment, which might be of value in improving communication applications.

In one embodiment, the vibrator supplies a controlled direction vibratory source using phased counter rotating weights based on centripetal force. Although explanation herein may focus on a borehole vibratory source, such embodiments are exemplary, and the vibrator could also be implemented in a surface mounted source sled or vehicle for other purposes. Likewise, the use cases discussed herein are not exhaustive and the vibrator may also have applications in other industries that are not discussed in this presentation.

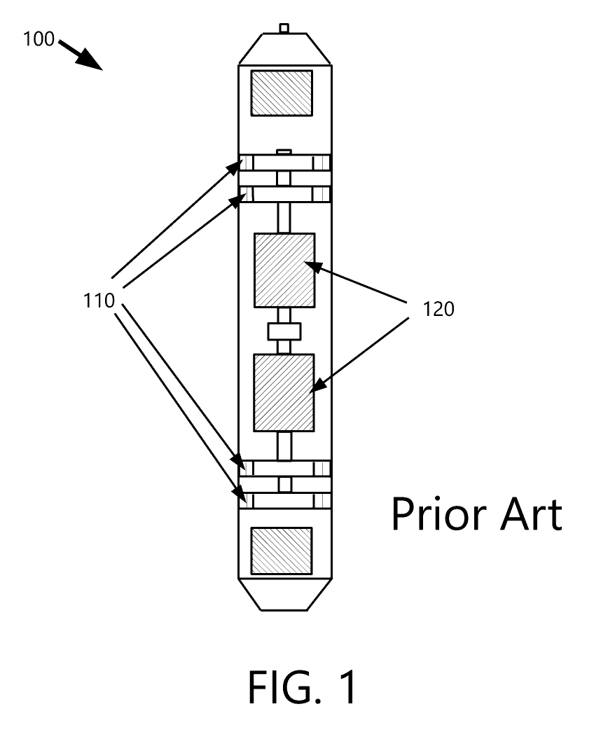

To better understand aspects of the embodiments herein, FIG. 1 is presented with an exemplary illustration of a prior art vibrator 100. This vibrator 100 has a set of eccentric weights 110 which are spun at various frequencies by one or more electric motors 120. The spinning eccentric weights 110 make the body of the vibrator 100 wobble at a rotational frequency as it is suspended in a borehole. This wobble can alternately compress and expand the borehole fluid which imparts an acoustic wave into the surrounding rock.

But this type of excitation has several limitations. First, only the frequency can be varied, not the wave type or propagation direction. Second, it emits simultaneous compressional (P) and shear (S) waves with a rotational component, which makes decoding the specific Sh and Sv velocities difficult.

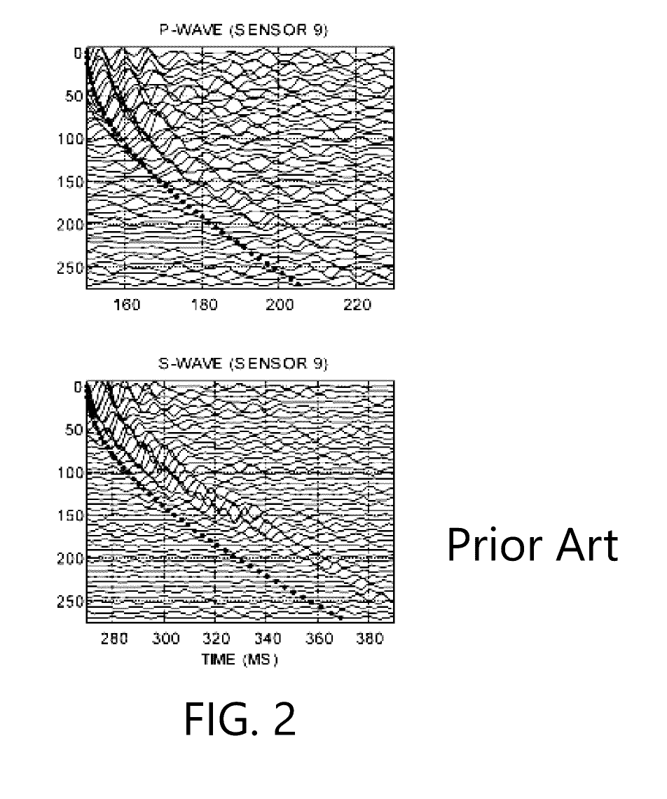

These waveforms are illustrated in FIG. 2. The illustrated noise is generated in large part by the wobble of the prior art vibrator 100.

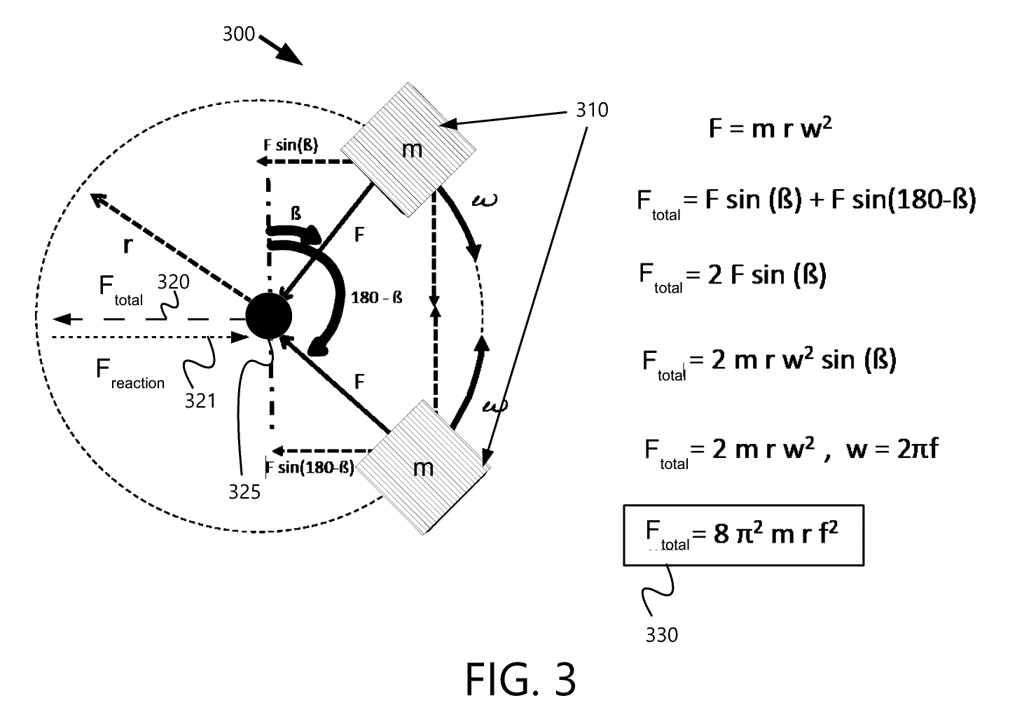

FIG. 3 is an exemplary partial view of a vibrator 300 having a pair of weights 310 that are rotated on a rotational axis 325. By rotating the weights 310 in opposite directions, exemplary physical relationships are produced based on the mass rotations. In this example, the two counter-rotating weights 310 are rotating toward each other such that their vertical forces cancel out but the horizontal forces do not. The equation representing the respective forces developed on the axis about which the weights are spinning is:

F=m*r*w² —Equation 1—

By counter rotating the weights at the same velocity, there will be two locations where the forces will add constructively. In the example of FIG. 3, this is in a horizontal direction, represented by Fₜₒₜₐₗ 320 and F_{reaction} 321.

When the weights are aligned in the same direction (i.e., on the horizontal Force direction) the force Fₜₒₜₐₗ 320 is twice that of a single weight. At all other times, the forces in line with the horizontal direction add, but the forces in the direction normal to the horizontal direction cancel. Thus the frame of the spinning weights result in a force equal to:

2*F sin(β) —Equation 2—

Substituting the value of F yields the max force equation 330 as shown in FIG. 3. By adjusting the relative positions of the eccentric weights on the central axis, one can make the direction where the weights constructively add to a maximum to any direction normal to the axis upon which the weights swing (i.e., the axis of rotation). Thus the direction of vibration may be adjusted to any direction normal to the axis of rotation in an embodiment.

In one embodiment, the system may adjust relative positions of the weights 310 dynamically, which can allow the system to send waves of different vibrational directions over time. For example if properly oriented, horizontal sheer force (Sh) could be sent followed by vertical sheer force (Sv) to study shear transmission. These dynamically changeable vibrations alternatively could be used to send communications through solid materials, such as the earth.

The system may accomplish the adjustment by receiving a user input in one embodiment and changing the rotation speed of at least one weight such that the weights will cross at a different point normal to the axis of rotation. The processor may then cause the weights to rotate at the same speed in order to maintain the direction of vibration defined by a line through the different point and the axis of rotation.

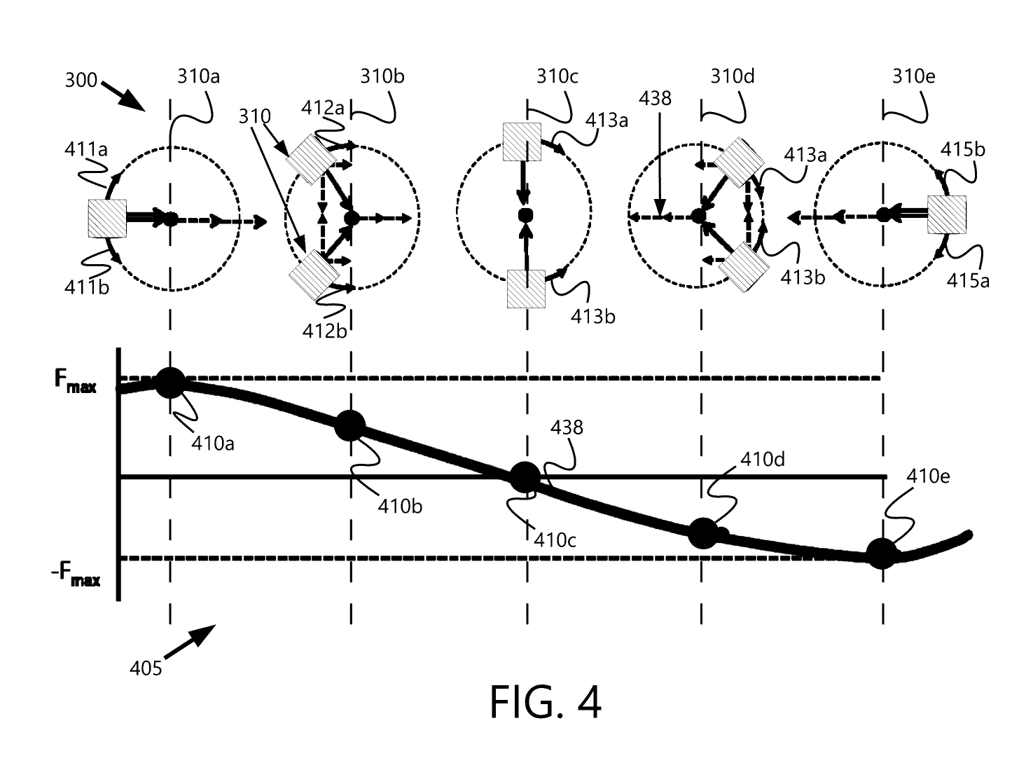

FIG. 4 is an exemplary partial illustration of the vibrator 300 of FIG. 3 as the weights 310 rotate through time at reference points 310a-e, and includes graph 405 of exemplary resulting forces 410a-e at each respective position 310a-e. As shown in chart 430 of FIG. 4, the resulting force 438 on the axis of rotation is a sinusoid.

The sinusoidal resulting force 438 may be a substantially pure directional vibrational force based on the counter-rotating weights 310. In this example, the weights 310 are of substantially identically mass and rotate in opposite directions. At the points when the weights come together (i.e., cross) at 310a and 310e, the net force is maximized. At the points when the weights are furthest from crossing at 310c, their forces on the rotational axis cancel and are substantially zero. Thus, the force oscillates back and forth in a direction 438 normal to the axis of rotation and passing through the points where the weights meet 310a and 310e on both sides of the axis of rotation

For example, at position 310a, the net force amount 410a is the sum of rotational forces 411a and 411b. Similarly, at position 310b, the net force amount 410b is the sum of 412a and 412b. At position 310c, the net force amount 410c is the sum of 413a and 413b. At position 310d, the net force amount 410d is the sum of 414a and 414b. At position 310e, the net force amount 410e is the sum of 415a and 415b.

As is also shown in FIG. 4, at each position 310a-e, the vertical force vectors cancel out whereas the horizontal force vectors do not. The result is the horizontal force oscillating back and forth on the horizontal direction 438.

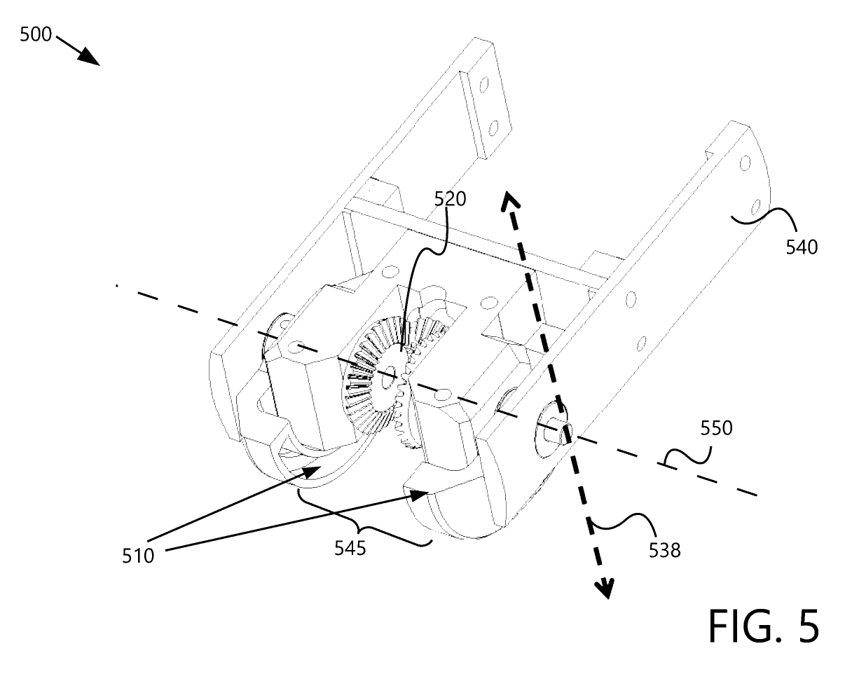

FIG. 5 includes an exemplary illustration of a vibrator assembly 500 in accordance with an embodiment. In this example, a pair of counter rotating weights 510 are driven in a counter-rotational manner by a bevel gear transmission 520. The weights 510 are aligned in this example such that the vibration direction 538 will be normal to the mounting struts 540 as drawn. In this embodiment, the weights 510 are displaced a distance 545 along the axis of rotation 550 to make room for the transmission. In another embodiment, the transition may include different motors for each weight, as will be discussed later herein.

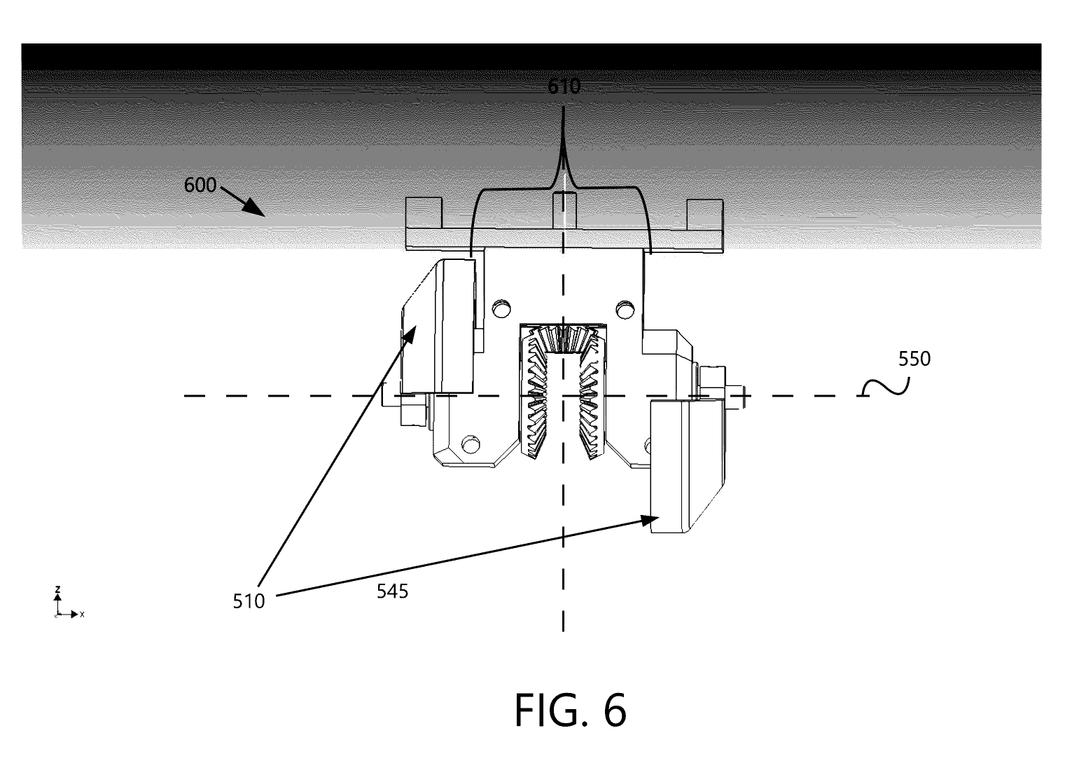

FIG. 6 includes an exemplary illustration of an end view of the vibrator 600 with the eccentric masses 510 aligned for axial motion out of the plane of the figure. However, the geometric displacement 610 of the masses causes an unwanted moment to develop which will rock the vibrator in a torsional mode along the axis pointing out of the figure.

It is possible to correct for this torsional mode by placing a second pair of weights in the system aligned in the same vibration direction, but operating at a phase of 180 degrees from its adjacent mass. In this way, the second pair of weights may be “mirrored” as compared to the first pair.

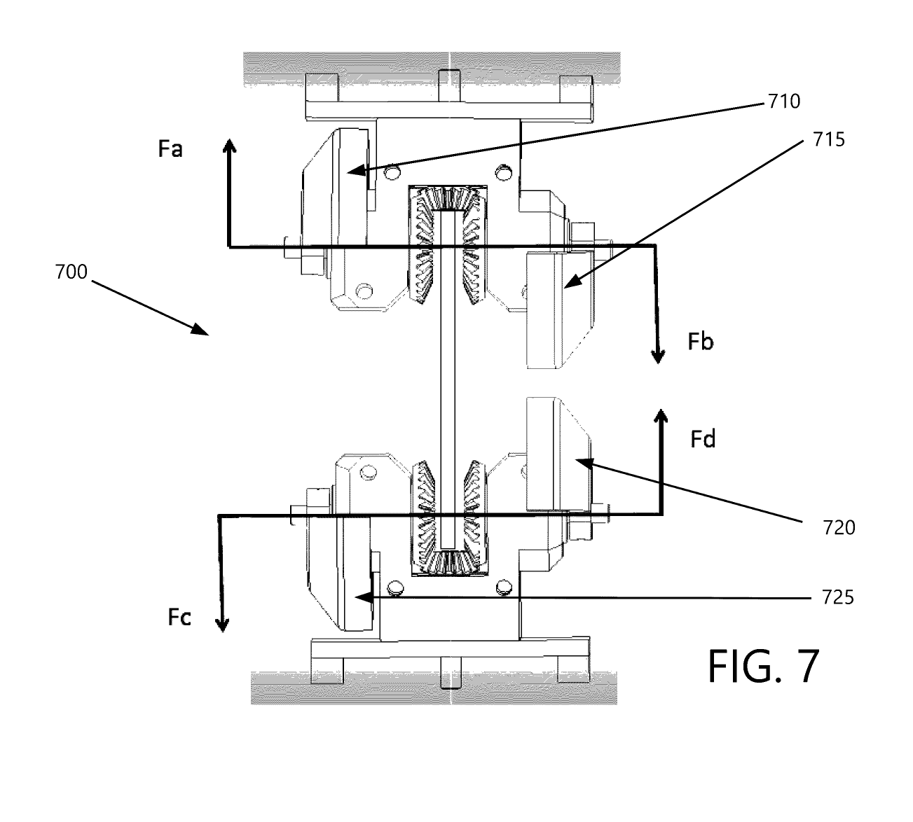

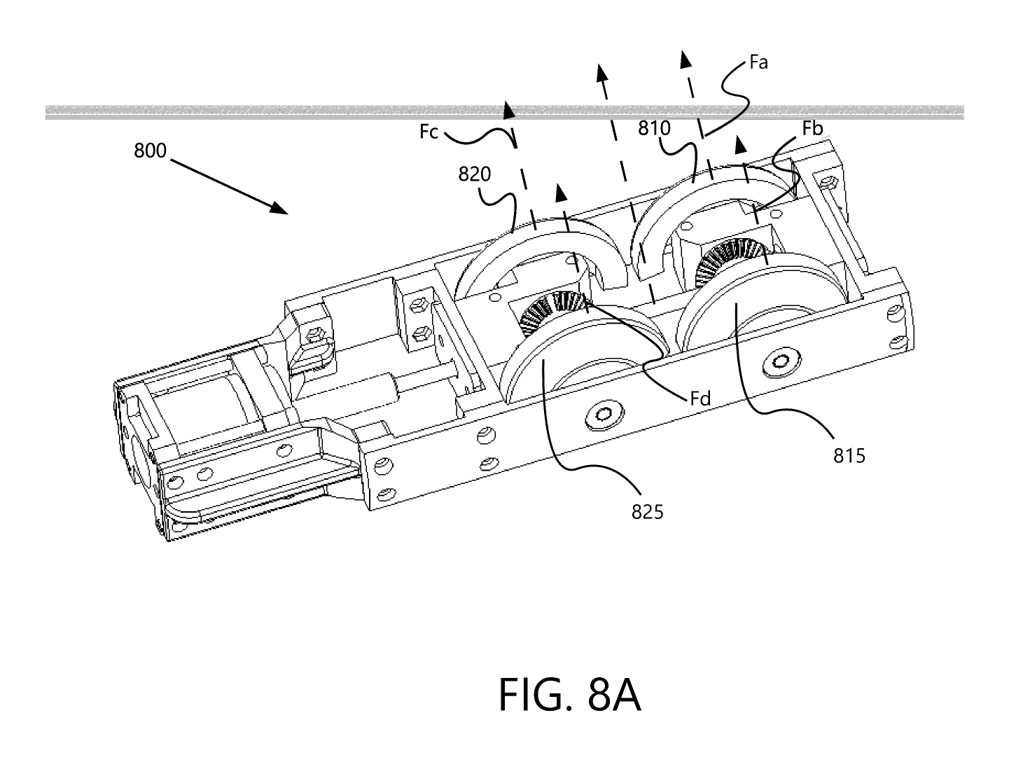

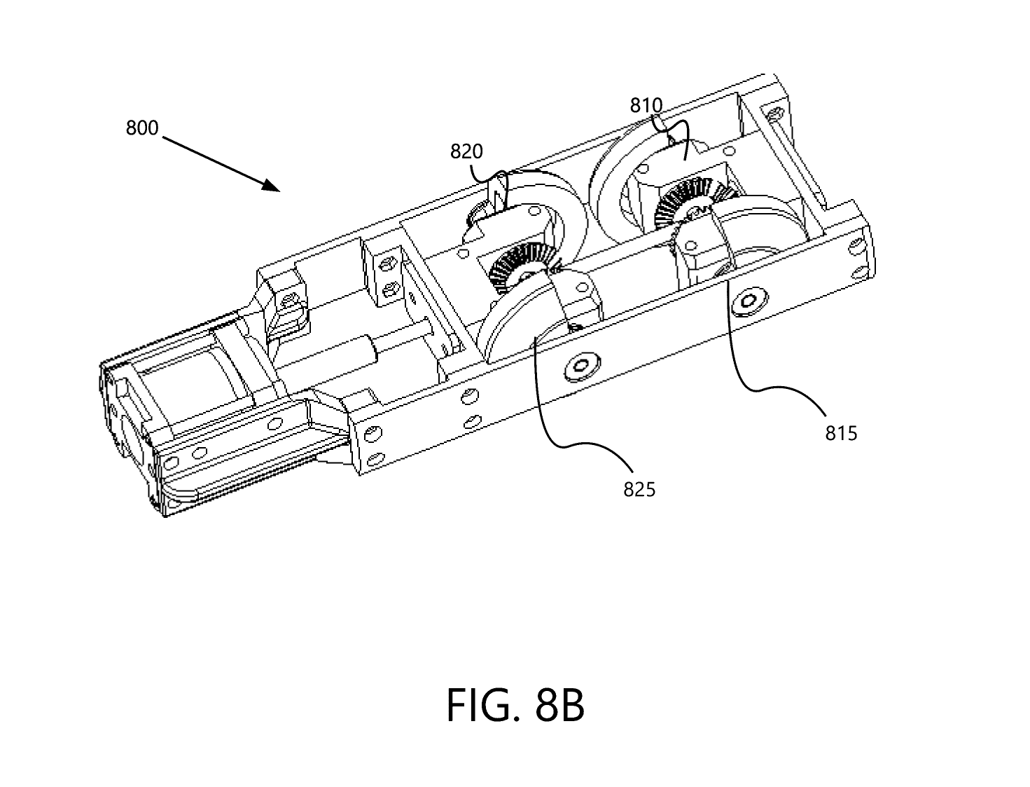

An example of a vibrator 700 with a second pair of mirrored weights 720 and 725 is illustrated in FIG. 7. The imbalance force Fa is countered by the reaction of force Fc, and the imbalance of force Fb is countered by force Fd. This is because the first pair of weights 710 and 715 rotates in parallel to the second pair of weights 720 and 725, but the second pair 720 and 725 is 180 degrees out of phase with the first pair 710 and 715. Thus, when weight 710 and weight 720 have fully rotated away from or fully rotated toward one another, their vertical forces cancel. Yet both pairs of weights 710, 715, 720, and 725 still cause an oscillating force in a direction coming into and out of the figure based on all of the weights coming to a maximum positions normal to the view of FIG. 7 at the same time (also illustrated in FIG. 8A). Said another way, the first pair of weights 710 and 715 may pass each other at a point coming out of the figure at the same time second pair of weights 720 and 725 pass each other at the point coming out of the figure. Thus, both sets of weights may be in phase to create additive vibrational forces in the same direction.

FIG. 8A shows an example embodiment of a balanced mass-corrected vibrator 800 using opposed counter rotating masses 810, 815, 820, and 825. In the illustration, the timing or phase of the weights is set up to have its peak additive force direction normal to the mounting body as shown by the four force vectors Fa, Fb, Fc, Fd, which all pointing in the same direction (i.e., the direction of vibration). If the weights counter-rotate at the same speed, the direction (i.e., axis) of vibration will be maintained, with the vibrational force fluctuating back and forth along that axis.

The transmission in this example is such that opposing weights 810, 815, 820, and 825 each rotate oppositely from the neighboring weights located beside and across. This may be more clearly seen in FIG. 8B where the transmission has rotated the masses to the zero force position. Note there is mirror symmetry with respect to nearest neighbors both across and beside, and the forces Fa, Fc and Fb, Fd cancel each other. For example, the forces of weights 810 and 820 cancel along path normal to both axes of rotation, as do the forces of weights 825 and 815.

The vibration strength of a set of eccentric masses 810, 815, 820, and 825 as shown in FIG. 8B is limited by the mass of the eccentric weights 810, 815, 820, and 825 and the frequency of operation. If one wished to increase the power, but spatial constraints such as borehole size limit the size of individual weights, then several of these modules 800 can be stacked normal to the eccentric weight axes to increase the power output. Each module 800 may be synchronized in an embodiment such that their forces fluctuate along a common direction together in unison in one embodiment.

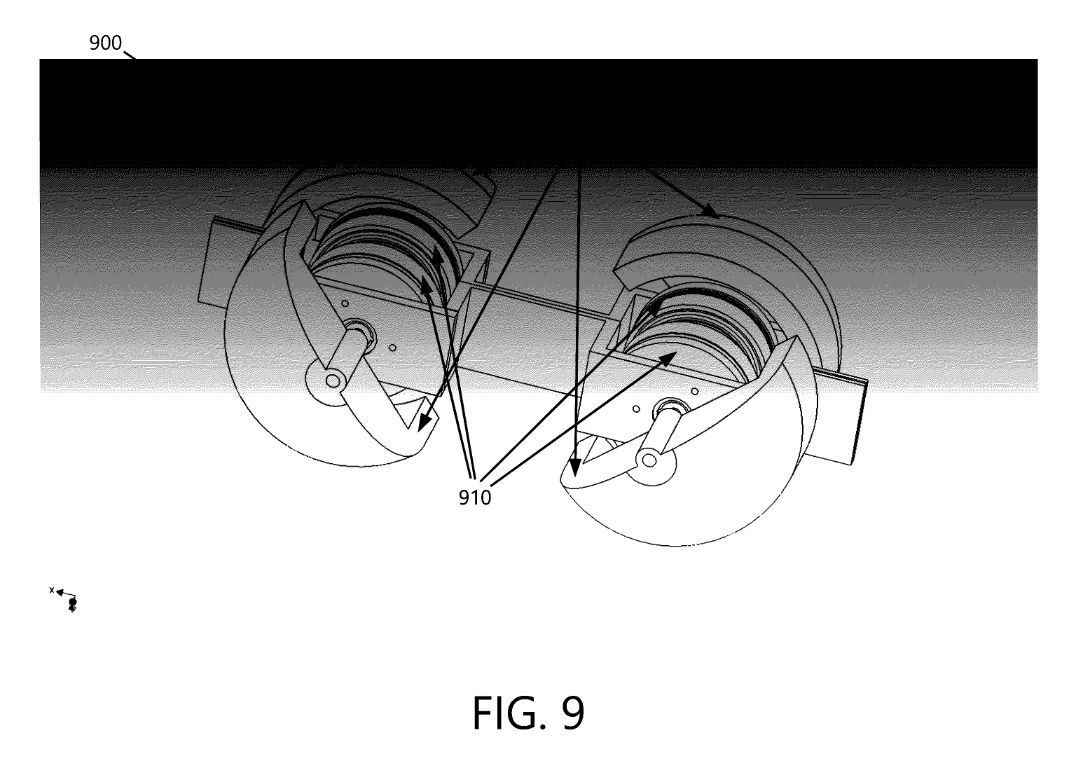

There are other embodiments in which the vibrator may utilize different motors for each mass, allowing for more vibrational control and fluctuation. For example, in FIG. 9, the vibrator 900 has been implemented using flat motors 910 with position encoders which are contained within the respective bodies of the masses 920. This may allow for a more compact package, and the ability to dynamically change the vibration direction by precessing the masses to new additive positions. In this design, each motor may be individually powered and controlled by software and a controller as opposed to the mechanical transmission described earlier.

In one embodiment, the motors are constructed such the rotating portion of the motor itself is the eccentric weight (not shown), further compacting the design.

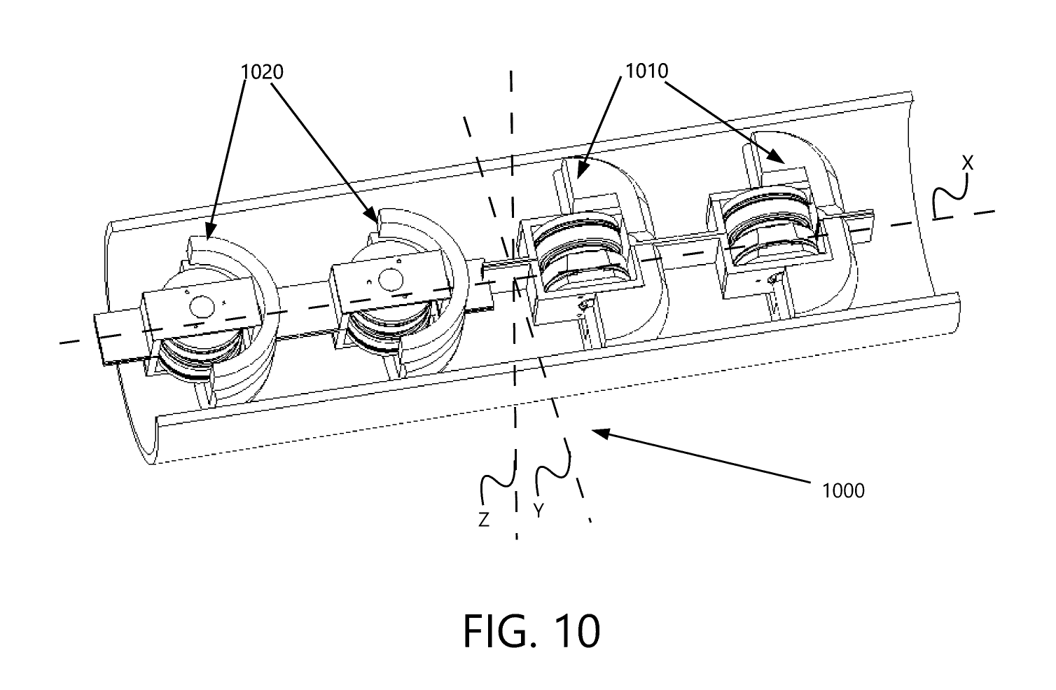

In addition to the single axis devices discussed so far, it is possible to construct a vibrator device with two orthogonal axes, meaning there are two axes on which separate sets of weights swing. An example embodiment of this design 1000 is shown in FIG. 10, using the concept of the flat motor introduced in FIG. 8. In this example, two orthogonal sets of eccentric masses 1010 and 1020 are aligned along the central axis X of the device 1000. A first set 1010 permits vibration in the XY plane, while the second set 1020 permits vibration in the XZ plane. With this configuration, a user could produce, P, Sh and Sv waves with respect to a borehole axis from a single device 1000.

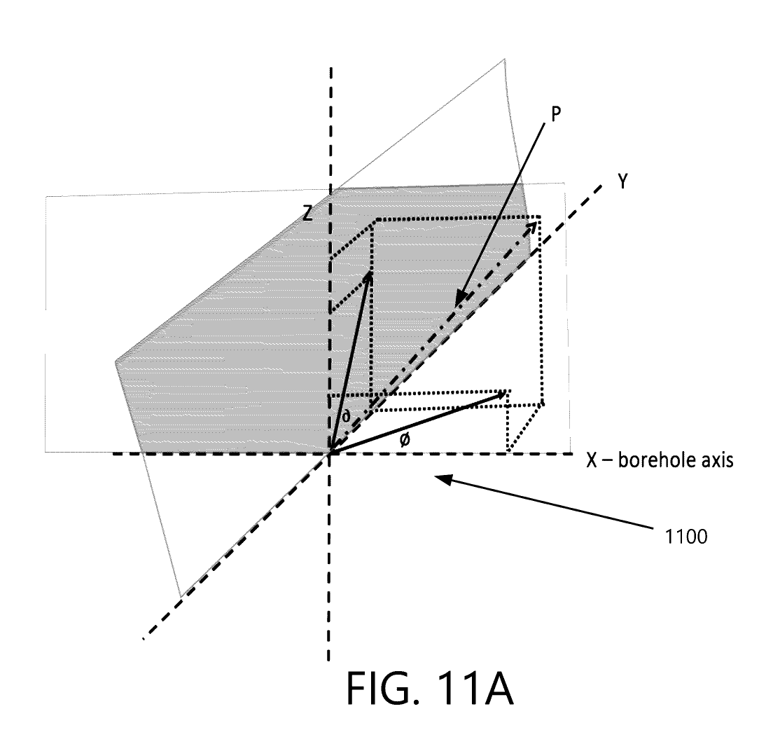

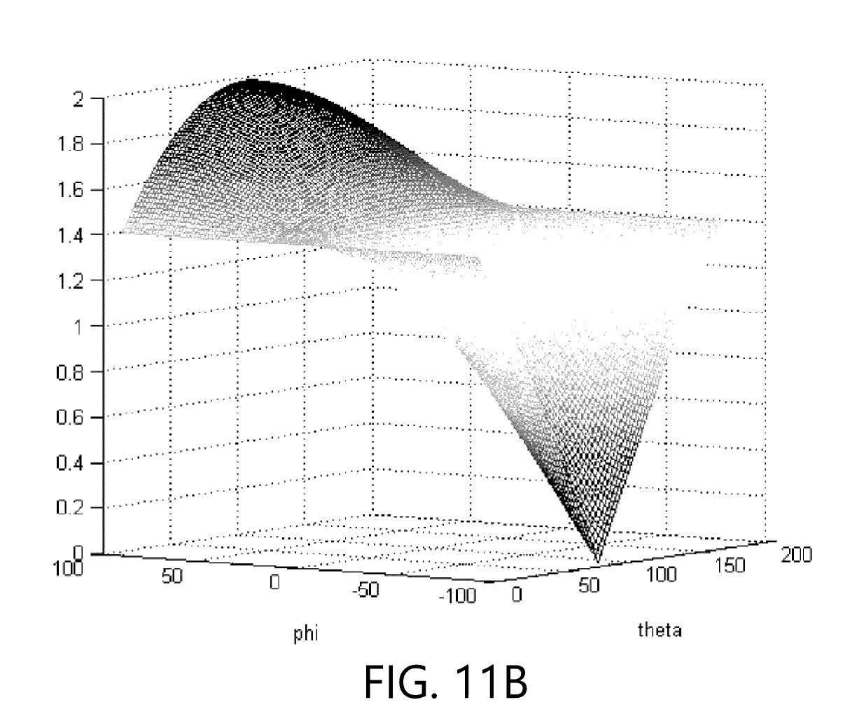

Further angular capabilities of a dual axis device 1000 are illustrated in FIGS. 11A and 11B. In the diagram 1100, one set of masses is normal to the x axis, and the second is normal to the y axis. At a given angle of ∂ and ø, the resultant angle of the vibration will be along the vector P, which is spatially outside of the XZ and YZ planes.

FIG. 11A shows the computed strength of the resulting vibration vector of the example device 1000 of FIG. 10. The strength will vary from two times force to zero depending on the operating angles chosen. Typically one would choose to operate in the positive phi direction to avoid the area near the singularity where all forces cancel, making the useful range about one to two times force.

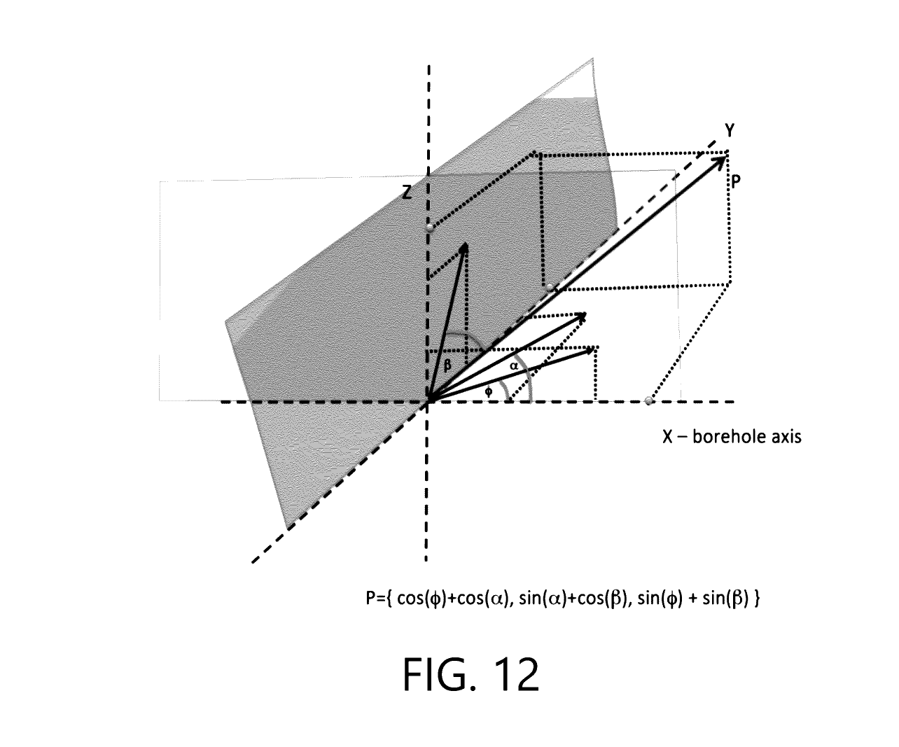

In a similar manner it is possible to construct a device with three orthogonal axes (i.e., three orthogonal sets of masses). A mathematical model is described in FIG. 12. Here, the resultant direction of vibration P is a function of the three angles: Å, β, and ø. In this embodiment, a single device may vibrate in any direction.

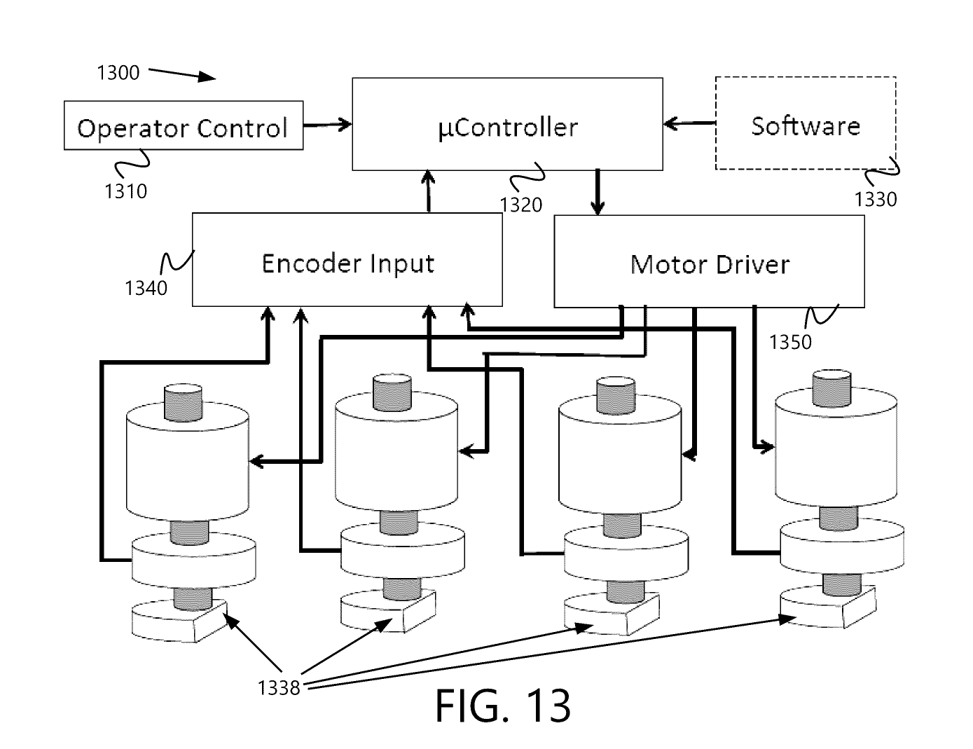

An example control system 1300 for a multi-mass, dynamically programmable vibratory source is illustrated in FIG. 13. Using this system it may be possible to drive each motor 1338 independently while tracking the rotational position of the associated mass. In an optimized uni-axial vibrating system a user can command all the motors to the same angular frequency and adjust the relative phases until the weights come to positions of additive force in the direction desired. This same system 1300 could change the vibration direction by dynamically precessing the weights 1338 to the new preferred direction. This could be of use in an earth exploratory program using Sh and Sv waves, or as a method of communication in the subsurface where information could be encoded in the frequency, vibratory direction or both.

In one embodiment, a user may control the system 1300 by using an operator control 1310, such as a touch screen, buttons, or joystick. User control would be input to the microcontroller 1320, which in turn may track position and command motor rotation and determine how much additional power to send to each motor to achieve the rotational effects dictated by the user. The microcontroller 1320 may execute software 1330 specific to the vibrator in one embodiment.

In another embodiment, the microcontroller may receive encoder input 1340 from encoders in the weights 1338 to determine the relative positions of the weights in one embodiment. This may allow the microcontroller 1320 to determine the relative locations of the weights 1338, and whether to drive 1350 particular motors more or less to adjust or maintain the vibration output according to the user controls.

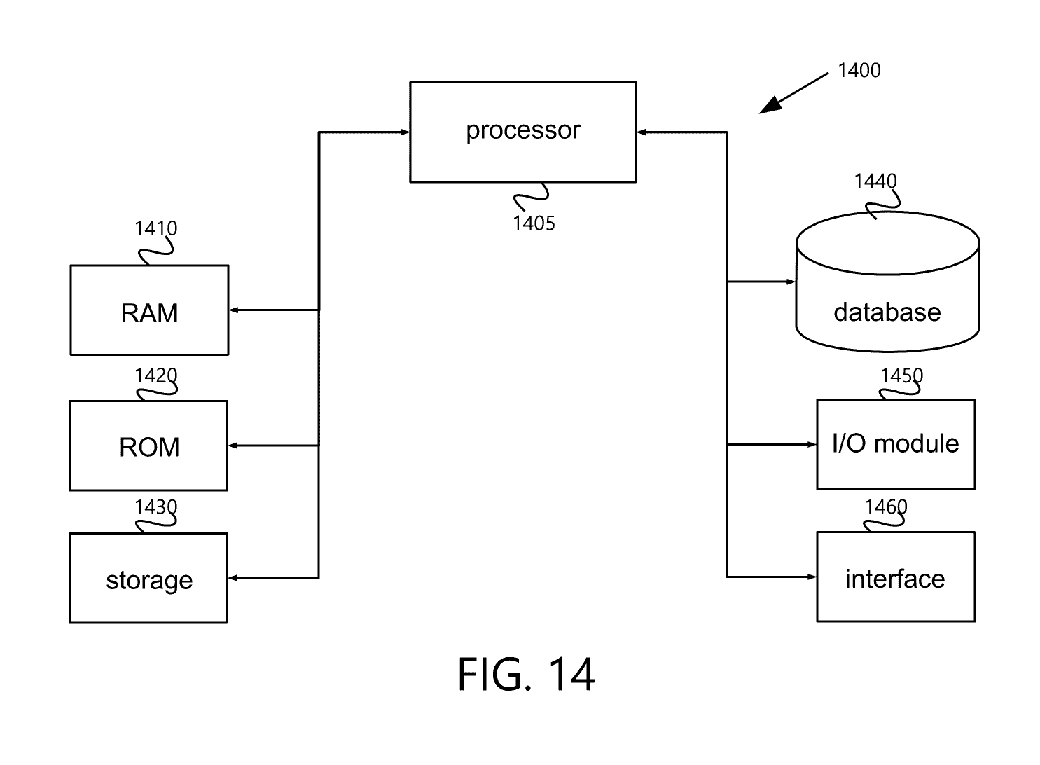

FIG. 14 depicts an exemplary processor-based computing system 1400, representative of the type of computing system that may be present in or used in conjunction with controlling a vibrator device. The computing system 1400 is exemplary only and does not exclude the possibility of another processor- or controller-based system being used in or with one of the aforementioned components. Additionally, a computing device or system need not include all the system hardware components in an embodiment.

In one aspect, system 1400 may include one or more hardware and/or software components configured to execute software programs, such as software for storing, processing, and analyzing data. For example, system 1400 may include one or more hardware components such as, for example, processor 1405, a random access memory (RAM) module 1410, a read-only memory (ROM) module 1420, a storage system 1430, a database 1440, one or more input/output (I/O) modules 1450, and an interface module 1460. Alternatively and/or additionally, system 1400 may include one or more software components such as, for example, a computer-readable medium including computer-executable instructions for performing methods consistent with certain disclosed embodiments. It is contemplated that one or more of the hardware components listed above may be implemented using software. For example, storage 1430 may include a software partition associated with one or more other hardware components of system 1400. System 1400 may include additional, fewer, and/or different components than those listed above. It is understood that the components listed above are exemplary only and not intended to be limiting.

Processor 1405 may include one or more processors, each configured to execute instructions and process data to perform one or more functions associated with system 1400. The term “processor,” as generally used herein, refers to any logic processing unit, such as one or more central processing units (CPUs), digital signal processors (DSPs), application specific integrated circuits (ASICs), field programmable gate arrays (FPGAs), and similar devices. As illustrated in FIG. 14, processor 1405 may be communicatively coupled to RAM 1410, ROM 1420, storage 1430, database 1440, I/O module 1450, and interface module 1460. Processor 1405 may be configured to execute sequences of computer program instructions to perform various processes, which will be described in detail below. The computer program instructions may be loaded into RAM for execution by processor 1405.

RAM 1410 and ROM 1420 may each include one or more devices for storing information associated with an operation of system 1400 and/or processor 1405. For example, ROM 1420 may include a memory device configured to access and store information associated with system 1400, including information for identifying, initializing, and monitoring the operation of one or more components and subsystems of system 1400. RAM 1410 may include a memory device for storing data associated with one or more operations of processor 1405. For example, ROM 1420 may load instructions into RAM 1410 for execution by processor 1405.

Storage 1430 may include any type of storage device configured to store information that processor 1405 may need to perform processes consistent with the disclosed embodiments.

Database 1440 may include one or more software and/or hardware components that cooperate to store, organize, sort, filter, and/or arrange data used by system 1400 and/or processor 1405. For example, database 1440 may include user account information, class information, device settings, and other user preferences or restrictions. Alternatively, database 1440 may store additional and/or different information. Database 1440 may also contain a plurality of databases that are communicatively coupled to one another and/or processor 1405, which may be one of a plurality of processors utilized by a server or computing device.

In one embodiment, the database 1440 may include one more tables that store power variables used to synchronize the weights and determine the correct speed to spin the weights to achieve the desired vibrations.

I/O module 1450 may include one or more components configured to communicate information with a user associated with system 1400. For example, I/O module 1450 may include a console with an integrated keyboard and mouse to allow a user to input parameters associated with system 1400. I/O module 1450 may also include a display including a graphical user interface (GUI) for outputting information on a monitor. I/O module 1450 may also include peripheral devices such as, for example, a printer for printing information associated with system 1400, a user-accessible disk drive (e.g., a USB port, a floppy, CD-ROM, or DVD-ROM drive, etc.) to allow a user to input data stored on a portable media device, a microphone, a speaker system, or any other suitable type of interface device.

Interface 1460 may include one or more components configured to transmit and receive data via a communication network, such as the Internet, a local area network, a peer-to-peer network, a direct link network, a wireless network, a vibration-based communication network that utilizes the earth, or any other suitable communication platform. For example, interface 1460 may include one or more modulators, demodulators, multiplexers, demultiplexers, network communication devices, wireless devices, antennas, modems, and any other type of device configured to enable data communication via a communication network. For example, the vibrator may be placed in a borehole underground and receive communications through the earth as part of the network.

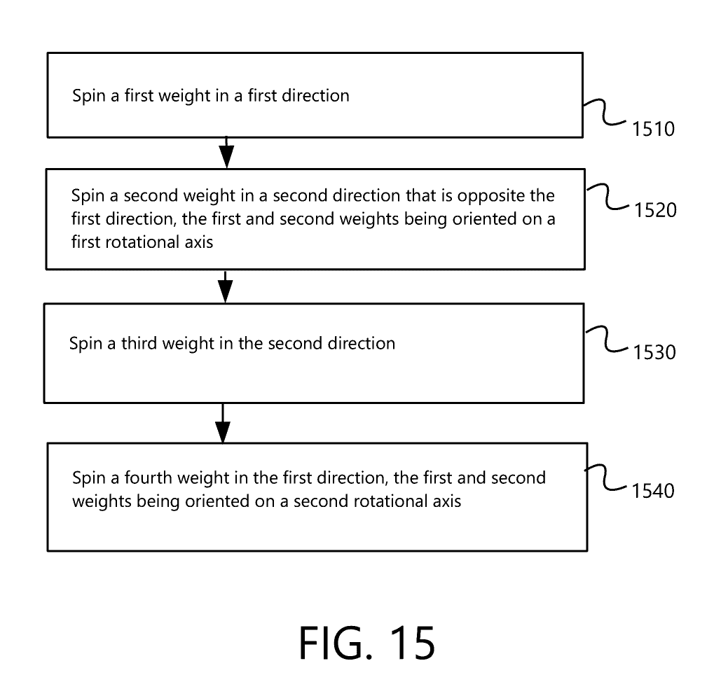

Turning to FIG. 15, an exemplary method is presented for controlling a vibrator. At step 1520, a controller may cause a first weight to spin in a first direction. The controller may also cause a second weight to spin in a second direction that is opposite the first direction, the first and second weights being oriented on a first rotational axis. The first and second weights may be the same in one embodiment, and the rates at which they spin in opposite directions may also be the same.

To correct a torsional mode, at step 1530 the microcontroller may spin a third weight in the second direction. At step 1540, the controller may spin a fourth weight in the first direction, the first and second weights being oriented on a second rotational axis.

The third weight may be located adjacent to the first weight in one embodiment, and the fourth weight may be adjacent to the second weight. In such an embodiment, the first and second rotational axes may be parallel to one another.

In another embodiment, the first and second rotational axes may be located in parallel planes but be out of phase with respect to one another.

Although the descriptions above contain many specifications, these should not be construed as limiting the scope of the invention but as merely providing illustrations of some of the presently preferred embodiments of this present invention. Persons skilled in the art will understand that the method and apparatus described herein may be practiced, including but not limited to, the embodiments described. Further, it should be understood that the invention is not to be unduly limited to the foregoing which has been set forth for illustrative purposes. Various modifications and alternatives will be apparent to those skilled in the art without departing from the true scope of the invention, as defined in the following claims. While there have been Illustrated and described particular embodiments of the present invention, it will be appreciated that numerous changes and modifications will occur to those skilled in the art, and it is intended in the appended claims to cover those changes and modifications which fall within the true spirit and scope of the present invention.

While the foregoing is directed to embodiments of the present invention, other and further embodiments of the invention may be devised without departing from the basic scope thereof, and the scope thereof is determined by the claims that follow.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A vibrator comprising:
a transmission assembly;
first and second weights coupled to the transmission assembly, wherein the first and second weights spin in opposite directions on a first axis of rotation;
third and fourth weights coupled to the transmission assembly, wherein the third and fourth weights spin in opposite directions on a second axis of rotation and the third weight spins in an opposite direction from the first weight.

2. The vibrator of claim 1, wherein the first axis of rotation is parallel to the second axis of rotation, and wherein the first and third weights are mirrored relative to one another and a first direction of vibration is normal to the first axis of rotation and extends through a point where the first and second weights pass one another.

3. The vibrator of claim 1, wherein the transmission assembly includes separate motors for at least the first and third weights.

4. The vibrator of claim 3, wherein the motors adjust a first phase of where the first and second weights pass each other to be consistent with as second phase of where the third and fourth weights pass each other.

5. The vibrator of claim 1, wherein the first and second weights are offset a distance from one another along the first axis of rotation, and the third and fourth weights are offset the same distance on the second axis of rotation.

6. The vibrator of claim 1, wherein the first, second, third, and fourth weights comprise a first module, and wherein the vibrator includes a second module having identical weights to the first module, the weights of the second module spinning synchronously with the weights of the first module.

7. The vibrator of claim 6, wherein the first and second modules are coupled along a direction of vibration that is normal to both the first and second axes of rotation.

8. The vibrator of claim 6, wherein the first module creates a first vibration force in a first direction, and the second module creates a second vibration force in a second direction, the first and second directions being variable with respect to one another.

9. The vibrator of claim 1, wherein the transmission assembly includes separate motors for the first, second, third, and fourth weights.

10. A method of producing vibrations using counter rotating weights, the method having steps comprising:
rotating a first weight in a first direction;
counter rotating a second weight in a second direction that is opposite the first direction, the first and second weights being oriented on a first rotational axis;
rotating a third weight in the second direction; and
counter rotating a fourth weight in the first direction, the first and second weights being oriented on a second rotational axis.

11. The method of claim 10, the steps further comprising altering a phase between the first weight and the counter rotating second weight to change an axis of vibration in real time without stopping the rotation of the first and second weights.

12. The method of claim 10, wherein rotating the third and fourth weights is performed to mirror the rotation of the first and second weights to minimize wobble caused by a spatial offset between the first and second weights.

13. The method of claim 10, further including rotating a mechanical transmission to drive the counter rotation of the second and fourth weights.

14. The method of claim 10, further including driving independent motors for each of the first, second, third, and fourth weights.

15. The method of claim 10, wherein at least the first and third weights include encoders, and wherein the method further includes receiving information from the encoders representing an encoded phase and adjusting the rotation of at least one of the first and third weights based on the encoded phase.

16. The method of claim 15, further including controlling, by a processor, a vibration direction based on the processor comparing an encoded phase and precessing the first or third weight to alter the vibration direction.

17. The method of claim 10, wherein the first, second, third, and fourth weights comprise a first set of weights, and wherein the steps further comprise spinning a second set of weights in mirrored synchronization with the first set of weights to increase a radiated power on a vibrational force axis of the first set of weights.

18. The method of claim 10, wherein the steps further comprise:
rotating three orthogonal sets of weights, each with a different orientation relative to the other two, wherein one of the three orthogonal sets includes the first, second, third, and fourth weights.

19. A vibrator comprising:
a body having a tool axis;
a first pair of counter-rotating weights that rotate on a rotation axis normal to the tool axis; and
a second pair of counter-rotating weights that mirror the first pair, wherein the first and second pairs rotate such that the weights are all in a plain formed by the rotation axis and tool axis at a same time.

20. The vibrator of claim 19, further including:
at least a first motor for the first pair of weights;
at least a second motor for the second pair of weights;
a processor that controls the first and second motors to adjust phase differences between the weights of the first and second pairs of weights.
